(19) United States
(12) Patent Application Publication
(10) Pub. No.: US 2026/0260464 A1
(43) Pub. Date: Sep. 3, 2026

(54) LEARNING APPARATUS AND INFORMATION PROCESSING APPARATUS

(71) Applicant: NEC Corporation, Tokyo (JP)

(72) Inventors: Kazuya KAKIZAKI, Tokyo (JP); Takuma AMADA, Tokyo (JP)

(73) Assignee: NEC Corporation, Tokyo (JP)

(21) Appl. No.: 19/489,950

(22) PCT Filed: Jun. 22, 2023
(86) PCT No.: PCT/JP2023/023138

§ 371 Date: Dec. 4, 2025

(51) Int. Cl. G06V 10/77; G06V 10/74; G06V 20/70

(52) U.S. Cl. CPC G06V 10/7715; G06V 10/761; G06V 20/70

(57) ABSTRACT

An information processing apparatus including: a feature extraction means for extracting features from an image; and a learning means for causing the feature extraction means to perform a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than to second features extracted from a second image labeled with the synthetic label.

### TECHNICAL FIELD

This disclosure relates to the technical field of learning apparatus information processing apparatus, information processing methods, and recording media.

### BACKGROUND ART

Non-Patent Literature 1 describes a technology in which a feature extraction model f_{θ} r face recognition is constructed using metric learning and the feature extraction model is used to detect deepfakes.

### CITATION LIST

### Non-Patent Literature

Non-Patent Literature 1: Sreeraj Ramachandran, Aakash Varma Nadimpalli, Ajita Rattani, An Experimental Evaluation on Deepfake Detection using Deep Face Recognition, IEEE International Carnahan Conference on Security Technology (ICCST) 2021

### SUMMARY

An object of the present disclosure is to provide a learning apparatus, an information processing apparatus, a learning method, and a recording medium that arm to accurately detect whether an image has been synthesized.

### Solution to Problem

A learning apparatus according to an example aspect includes: a feature extraction means for extracting features from an image; and a learning means for causing the feature extraction means to perform a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than to second features extracted from a second image labeled with the synthetic label.

An information processing apparatus according to a first example aspect includes: a first feature extraction means that has performed a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than second features extracted from a second image labeled with the synthetic label; a first calculation means that calculates a similarity between target features extracted by the first feature extraction means from a target image that is to be determined as to whether or not it has been synthesized, and reference features extracted by the first feature extraction means from a reference image; a determination means that performs a determination whether or not the target image has been synthesized by determining a threshold value of the similarity; and an output means that produces an output according to a result of the determination by the determination means.

An information processing apparatus according to a second example aspect includes: a second feature extraction means that has performed a second learning of the feature extraction operation so that features extracted from images with the same label are more similar to each other than features extracted from images with different labels using a second image set labeled to identify individuals, wherein the second feature extraction means that has performed a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than second features extracted from a second image labeled with the synthetic label; a second calculation means that calculates a similarity between target features extracted by the second feature extraction means from a target image of a determination target on whether or not the person is the person in question, and reference features extracted by the second feature extraction means from a reference image; a second determination means that performs a determination whether the determination target is the person in question or not by a threshold determination for the similarity; and an output means for outputting according to a result of the determination by the second determination means.

An information processing method according to an example aspect includes: extracting features from an image using a feature extraction model; and causing the feature extraction model to perform a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than to second features extracted from a second image labeled with the synthetic label.

A recording medium according to an example aspect is a recording medium on which a computer program that allows a computer to execute an information processing method is recorded, the information processing method including: extracting features from an image using a feature extraction model; and causing the feature extraction model to perform a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than to second features extracted from a second image labeled with the synthetic label.

The learning apparatus, information processing apparatus, learning method, and recording medium disclosed herein are capable of accurately detecting whether an image has been synthesized.

### BRIEF DESCRIPTION OF DRAWINGS

FIG. 1 is a block diagram illustrating a configuration of a learning apparatus according to this disclosure.

FIG. 2 is a block diagram illustrating a configuration of a learning apparatus according to this disclosure.

FIG. 3 is a flowchart illustrating a flow of a learning operation of a learning apparatus according to this disclosure.

FIG. 4 is a block diagram illustrating a configuration of a learning apparatus according to this disclosure.

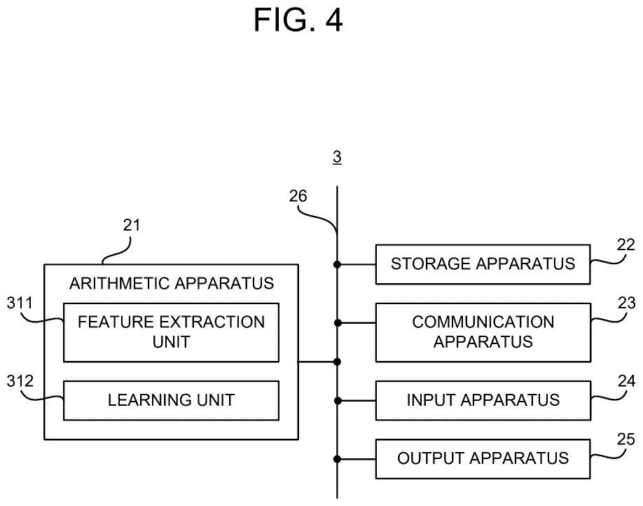

FIG. 5 is a block diagram illustrating a configuration of a learning apparatus according to this disclosure.

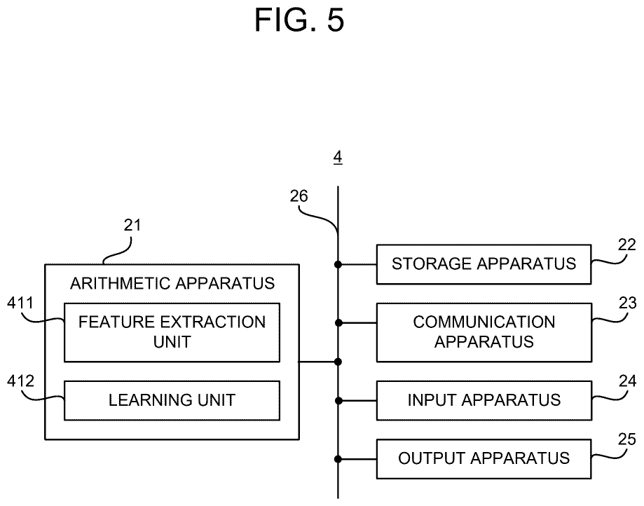

FIG. 6 is a block diagram illustrating a configuration of a learning apparatus according to this disclosure.

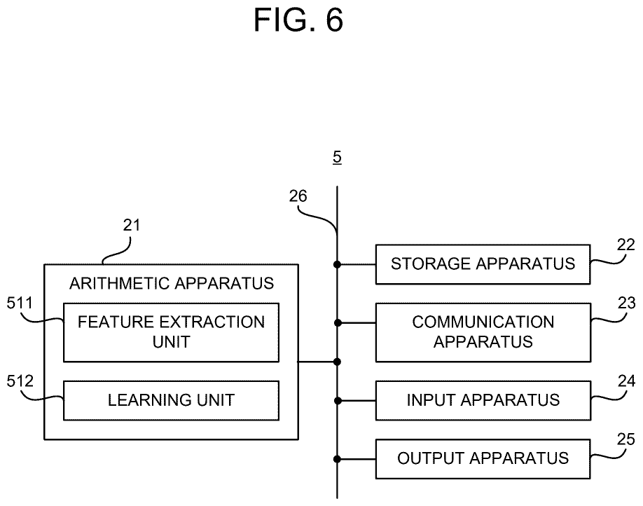

FIG. 7 is a block diagram illustrating a configuration of an information processing apparatus according to this disclosure.

FIG. 8 is a flowchart illustrating a flow of an information processing operation of an information processing apparatus according to this disclosure.

FIG. 9 is a block diagram illustrating a configuration of an information processing apparatus according to this disclosure.

FIG. 10 is a flowchart illustrating a flow of an information processing operation of an information processing apparatus according to this disclosure.

### DESCRIPTION OF EXAMPLE EMBODIMENTS

The following describes example embodiments of the learning apparatus, information processing apparatus, learning method, and recording medium with reference to the drawings.

### 1: First Example Embodiment

A first example embodiment of learning apparatus, information processing apparatus, learning method, and recording medium will be described below. Below, the first example embodiment of the learning apparatus, information processing apparatus, learning method, and recording medium will be described using a learning apparatus 1 according to the present disclosure.

### [1-1: Configuration of the Learning Apparatus 1]

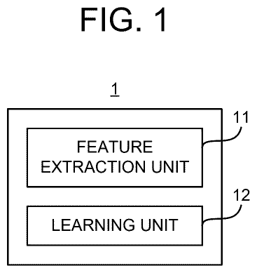

FIG. 1 is a block diagram showing the configuration of the learning apparatus 1 according to the present disclosure. As shown in FIG. 1, the learning apparatus 1 includes a feature extraction unit 11 and a learning unit 12.

The feature extraction unit 11 extracts features from an image. The learning unit 12 causes the feature extraction unit 11 to perform a first learning of a feature extraction operation. The first learning is metric learning. The learning unit 12 performs the first learning of the feature extraction operation using a first image set including images labeled with a non-synthetic label, indicating that they are not synthesized images, and images labeled with a synthetic label, indicating that they are synthesized images. The learning unit 12 performs the first learning of the feature extraction operation so that first features extracted from the first images labeled with the non-synthetic label are more similar to third features extracted from a third image different from the first image labeled with the non-synthetic label than second features extracted from a second image labeled with the synthetic label.

### [1-2: Technical Effects of the Learning Apparatus 1]

The learning apparatus 1 disclosed herein performs metric learning using an image set that includes images labeled with the non-synthetic label and images labeled with the synthetic label. This enables the generation of a feature extraction unit that extracts features that can detect whether an image is synthetic.

### 2: Second Example Embodiment

A second example embodiment of the learning apparatus, information processing apparatus, learning method, and recording medium will be described below. The second example embodiment of the learning apparatus, information processing apparatus, learning method, and recording medium will be described below using a learning apparatus 2 according to the present disclosure.

### [2-1: Fake Image]

There is a technology that synthesizes an image of a target based on information from a single photograph of a target. For example, there is a technology that synthesizes an image of a person based on information from a single photograph of that person's face. Deepfake, for example, is a known technology for synthesizing images of person. Deepfake is known as a technology for synthesizing fake images that depict events that did not actually occur. Hereinafter, an image depicting events that did not actually occur will sometimes be referred to as the fake image. The synthesized image will also sometimes be referred to as the fake image. An image depicting events that actually occurred will also sometimes be referred to as the real image.

In case where features that indicate the likelihood of the image being fake and features that indicate the likelihood of the image being real can be extracted, it is possible to determine whether a target image of a determination target is the fake image or the real image based on the features extracted from the target image. Below, how to generate a feature extraction model f_{θ} that can extract features appropriate for determining whether an image is fake or not, will be explained.

### [2-2: Configuration of the Learning Apparatus 2]

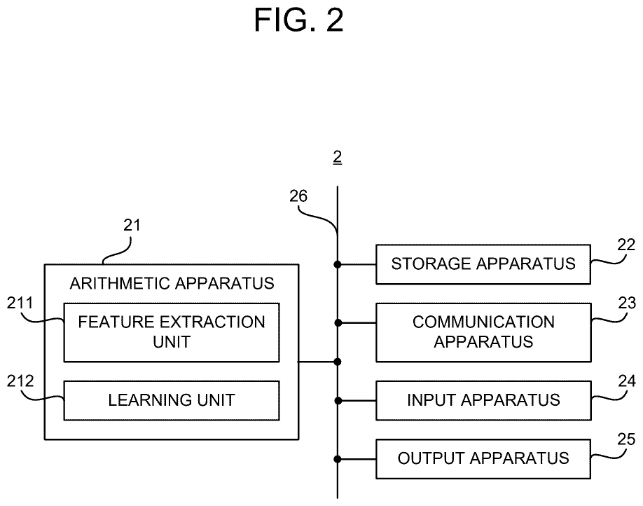

FIG. 2 is a block diagram showing the configuration of the learning apparatus 2. As shown in FIG. 2, the learning apparatus 2 includes an arithmetic apparatus 21 and a storage apparatus 22. The learning apparatus 2 may also include a communication apparatus 23, an input apparatus 24, and an output apparatus 25. However, the learning apparatus 2 does not have to include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 includes, for example, at least one of a CPU (Central Processing Unit), a GPU (Graphics Processing Unit), and an FPGA (Field Programmable Gate Array). The arithmetic apparatus 21 loads a computer program. For example, the arithmetic apparatus 21 may load a computer program stored in the storage apparatus 22. For example, the arithmetic apparatus 21 may load a computer program stored in a non-transitory computer-readable storage medium using a storage medium reader (e.g., the input apparatus 24, described below) included in the learning apparatus 2. The arithmetic apparatus 21 may acquire (i.e., download or load) the computer program from an apparatus (not shown) located outside the learning apparatus 2 via the communication apparatus 23 (or another communication apparatus). The arithmetic apparatus 21 executes the loaded computer program. As a result, logical functional blocks for executing the operations to be performed by the learning apparatus 2 are realized within the arithmetic apparatus 21. In other words, the arithmetic apparatus 21 is capable of functioning as a controller for realizing logical functional blocks for executing the operations (in other words, processing) that the learning apparatus 2 should perform.

The storage apparatus 22 is capable of storing desired data. For example, the storage apparatus 22 may temporarily store a computer program executed by the arithmetic apparatus 21. The storage apparatus 22 may temporarily store data that the arithmetic apparatus 21 temporarily uses in case where the arithmetic apparatus 21 is executing a computer program. The storage apparatus 22 may store data that the learning apparatus 2 will store long-term. The storage apparatus 22 may include at least one of RAM (Random Access Memory), ROM (Read Only Memory), a hard disk apparatus, a magneto-optical disk apparatus, an SSD (Solid State Drive), and a disk array apparatus. In other words, the storage apparatus 22 may include a non-transitory recording medium.

The communication apparatus 23 may communicate with apparatuses external to the learning apparatus 2 via a communication network (not shown). The communication apparatus 23 may be a communication interface based on standards such as Ethernet (registered trademark), Wi-Fi (registered trademark), Bluetooth (registered trademark), or USB (Universal Serial Bus).

The input apparatus 24 is an apparatus that accepts information input to the learning apparatus 2 from outside the learning apparatus 2. For example, the input apparatus 24 may include an operating apparatus (e.g., at least one of a keyboard, mouse, and touch panel) that can be operated by an operator of the learning apparatus 2. For example, the input apparatus 24 may include a reading apparatus that can read information recorded as data on a recording medium that can be externally attached to the learning apparatus 2.

The output apparatus 25 is an apparatus that outputs information to the outside of the learning apparatus 2. For example, the output apparatus 25 may output information as an image. In other words, the output apparatus 25 may include a display apparatus (a so-called display) that can display an image showing the information to be output. For example, the output apparatus 25 may output information as sound. In other words, the output apparatus 25 may include a sound apparatus (a so-called speaker) that can output sound. For example, the output apparatus 25 may output information on paper. In other words, the output apparatus 25 may include a printing apparatus (so-called printer) that can print desired information on paper.

FIG. 2 shows an example of a logical functional block realized within the arithmetic apparatus 21 for performing information processing operations. As shown in FIG. 2, the arithmetic apparatus 21 realizes a feature extraction unit 211, which is a specific example of a “feature extraction means” described in the supplemental note below, and a learning unit 212, which is a specific example of a “learning means” described in the supplemental note below.

### [2-3: Learning Operations Performed by the Learning Apparatus 2]

The feature extraction unit 211 performs the feature extraction operation to extract features from an image. The feature extraction unit 211 may extract features that indicate the likelihood of the fake image and features that indicate the likelihood of the real image from the image. The feature extraction unit 211 performs the feature extraction operation using the feature extraction model f_{θ}. In case where an image is input, the feature extraction model f_{θ} outputs the features of the image.

The learning unit 212 causes the feature extraction model f_{θ} to perform the first learning of the feature extraction operation. The first learning of the feature extraction operation is learning to make the first features extracted from a first image labeled with the non-synthetic label be more similar to the third features extracted from a third image labeled with the non-synthetic label than to the second features extracted from a second image labeled with the synthetic label. In other words, the first learning of the feature extraction operation is the metric learning.

The feature extraction model f_{θ} may be, for example, a model whose architecture includes a convolutional neural network (CNN). In other words, the feature extraction model f_{θ} may be generated by deep learning.

The learning unit 212 causes the feature extraction model f_{θ} to perform the first learning of the feature extraction operation using the first image set D_{df}. The first image set D_{df} includes images labeled with the non-synthetic label, indicating that they are not synthesized, and images labeled with the synthetic label, indicating that they are synthesized. The learning unit 212 performs the first learning of the feature extraction operation so that the first features extracted from the first image labeled with the non-synthetic label are more similar to the third features extracted from the third image different from the first image labeled with the non-synthetic label than to the second features extracted from the second image labeled with the synthetic label.

The feature extraction model f_{θ} is a model that has not undergone any other learning before performing the first learning. Any value may be used as the initial value of the parameter θ of the feature extraction model f_{θ}. For example, a randomly set value may be used as the initial value of the parameter θ of the feature extraction model f_{θ} to prevent bias in the weight distribution during learning.

The learning unit 212 optimizes the learnable parameter θ. For example, in case where the parameter θ is fixed, the parameter θ is not learnable. In the second example embodiment, all parameters θ of the feature extraction model f_{θ} may be learnable.

The learning unit 212 may use the first image set D_{df} expressed as in Formula 1 below.

$${D}_{df} = {\{ {( {x}_{r e a l}^{1} , {x}_{r e a l}^{2} , {x}_{f a k e} )}_{i} \}}_{i = 1}^{N} \qquad [ Formula 1 ]$$

xᵣₑₐₗ¹ and xᵣₑₐₗ² are the real images, and x_{fake} is the fake image. In other words, the first image set D_{df} includes N sets of two real images and one fake image. The learning unit 212 may use the first image set D_{df} including N sets of two real images and one fake image.

In this case, the first image may be xᵣₑₐₗ¹ in Formula 1 above. The second image may be x_{fake} in Formula 1 above. The third image may also be xᵣₑₐₗ² in Formula 1 above.

The learning unit 212 uses a loss function to adjust the parameter θ of the feature extraction model f_{θ}. The learning unit 212 uses a loss function that reduces the loss in case where a similarity between the first features and the second features is smaller than the similarity between the first features and the third features.

The feature extraction model f_{θ} may output, for example, a d-dimensional feature vector R_{d} as the features. In this case, the learning unit 212 uses a loss function that reduces the loss in case where the distance between the first feature vector R_{d} and the third feature vector R_{d} is smaller than the distance between the first feature vector R_{d} and the second feature vector R_{d}.

The learning unit 212 may employ, for example, triplet loss as the loss function for metric learning. In case where triplet loss is used as the loss function, it can be expressed as in Formula 2 below.

$$[ Formula 2 ]$$

$$Loss ( θ , {x}_{r e a l}^{1} , {x}_{r e a l}^{2} , {x}_{f a k e} ) = {[ dist ( {f}_{θ} ( {x}_{r e a l}^{1} ) , {f}_{θ} ( {x}_{r e a l}^{2} ) ) - dist ( {f}_{θ} ( {x}_{r e a l}^{1} ) , {f}_{θ} ( {x}_{f a k e} ) ) + α ]}_{+}$$

Formula 2 above expresses a loss function in which the loss decreases in case where the distance between the first feature vector extracted from xᵣₑₐₗ¹ (the first image labeled with the non-synthetic label) and the third feature vector extracted from xᵣₑₐₗ² (the third image labeled with the non-synthetic label) is smaller than the distance between the first feature vector extracted from xᵣₑₐₗ¹ (the first image labeled with the non-synthetic label) and the second feature vector extracted from x_{fake} (the second image labeled with the synthetic label). The feature extraction model f_{θ} learns the feature extraction operation so that features extracted from images labeled with the same label are close to each other and features extracted from images labeled with different labels are farther apart. α is a hyperparameter representing the margin.

The learning unit 212 adjusts the parameter θ of the feature extraction model f_{θ} to minimize the loss of the loss function, thereby optimizing the feature extraction model f_{θ}. That is, the learning unit 212 adjusts the parameter θ of the feature extraction model f_{θ} to realize the following Formula 3. The learning unit 212 optimizes the feature extraction model f_{θ} by adjusting the parameter θ to minimize the sum of the losses calculated from each of the N sets.

$${min}_{θ} {\sum }_{( {x}_{r e a l}^{1} {x}_{real}^{2} , {x}_{fake} ) ∈ {D}_{df}} Loss ( θ , {x}_{r e a l}^{1} , {x}_{r e a l}^{2} , {x}_{fake} ) \qquad [ Formula 3 ]$$

As an example, the case where triplet loss is used as the loss function is explained, but the loss function is not restricted to triplet loss. For example, any loss function suitable for the metric learning, such as ArcFace, can be used.

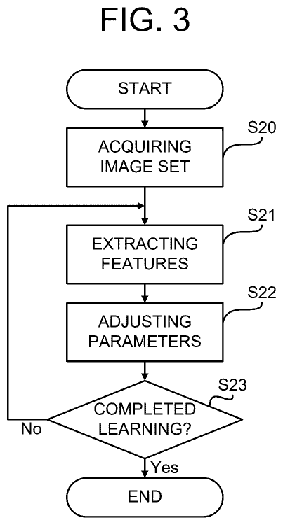

The learning operation performed by the learning apparatus 2 will be explained with reference to FIG. 3. FIG. 3 is a flowchart showing an example of the flow of the learning operation performed by the learning apparatus 2.

As shown in FIG. 3, the learning unit 212 acquires the first image set D_{df} (step S20). The learning unit 212 may acquire the first image set D_{df} via the communication apparatus 23 or the input apparatus 24. The learning unit 212 may also acquire the first image set D_{df} stored in the storage apparatus 22.

The feature extraction unit 211 extracts features from each of the three images included in the set using the feature extraction model f_{θ} (step S21). The learning unit 212 adjusts the parameter θ of the feature extraction model f_{θ} using a loss function (step S22).

The learning unit 212 determines whether to end learning (step S23). Learning may be ended, for example, in case where the above Formula 3 is satisfied. Alternatively, the end of learning may be, for example, in case where the learning operation has been performed for all N sets. In this case, the N sets may be a sufficient amount of learning data for sufficient learning. In case where learning is not to be ended (step S23: No), the process returns to step S21. In case where learning is to be ended (step S23: Yes), the desired feature extraction model f_{θ} is generated.

### [2-4: Technical Effects of the Learning Apparatus 2]

The technology disclosed in the Non-Patent Literature 1, in which the feature extraction model f_{θ} r face recognition is constructed using metric learning and the feature detection model is used to detect the fake image, is referred to as the “Comparative Example.” The feature extraction model f_{θ} r face recognition is not trained for the purpose of distinguishing between the fake image and the real image.

The learning apparatus 2 disclosed herein generates the feature extraction model f_{θ} using metric learning, with the purpose of distinguishing between the fake image and the real image, using an image set that includes images labeled with the non-synthetic label, indicating that they are not synthesized, and images labeled with the synthetic label, indicating that they are synthesized. Therefore, the learning apparatus 2 can generate the feature extraction model f_{θ} that has better performance in distinguishing between the fake image and the real image than the comparative example.

### 3: Third Example Embodiment

A third example embodiment of the learning apparatus, information processing apparatus, learning method, and recording medium will be described below. Below, the third example embodiment of the learning apparatus, information processing apparatus, learning method, and recording medium will be described using a learning apparatus 3 according to the present disclosure.

### [3-1: Learning Operation Performed by the Learning Apparatus 3]

In the third example embodiment, a learning unit 312 causes a face matching feature extraction model f_{θFace}, which has performed the second learning of the feature extraction operation, to perform the first learning of the feature extraction operation. That is, the third example embodiment differs from the second example embodiment in that the feature extraction model f_{θ} performs the second learning before performing the first learning.

The second learning of the feature extraction operation is performed using a second image set to which a label identifying an individual is attached. The second learning of the feature extraction operation is learning to operate so that features extracted from images with the same label are more similar than features extracted from images with different labels. The face matching feature extraction model f_{θFace} that has undergone the second learning outputs similar features in case where images of the same person are input, and outputs dissimilar features in case where images of different person are input.

In other words, in the third example embodiment, the initial value of the feature extraction model f_{θ} for performing the first learning of the feature extraction operation is different from that in the second example embodiment. The initial value of the parameter θ of the feature extraction model f_{θ} in the third example embodiment may be a value that is optimally adjusted by the second learning of the feature extraction operation. The initial value of the parameter θ of the feature extraction model f_{θ} may be a value suitable for identifying individuals. The initial value of the parameter θ of the feature extraction model f_{θ} may be a value suitable for face matching.

The first learning of the feature extraction operation is performed using the first image set D_{df}, as in the second example embodiment. The first learning of the feature extraction operation, as in the second example embodiment, is learning to make the first features extracted from the first image labeled with the non-synthetic label behave more similarly to the third features extracted from the third image labeled with the non-synthetic label than to the second features extracted from the second image labeled with the synthetic label.

The learning unit 312 causes the feature extraction model, which has learned the feature extraction operation to extract features suitable for identifying individuals from an image, to perform additional learning of the feature extraction operation to extract features suitable for determining whether or not it is the fake image from an image.

### [3-2: Modification]

The learning unit 312 may perform additional learning on a feature extraction model f_{θ} obtained by adding a layer g_{θ′} to the face matching feature extraction model f_{θFace} that has undergone the second learning. The additional layer g_{θ′} may receive the output of the face matching feature extraction model f_{θFace} as input and output features. In this case, the feature extraction model f_{θ} may be expressed as in Formula 4 below.

$${g}_{{θ}^{′}} ∘ {f}_{θ Face} \qquad [ Formula 4 ]$$

The learning unit 312 may adjust the parameter θ_{Face} of the face matching feature extraction model f_{θFace} and the parameter θ ′ of the additional layer gθ′. Alternatively, the learning unit 312 may fix the parameter θ_{Face} of the face matching feature extraction model f_{θFace} and not adjust the parameter θ_{Face}, and perform additional learning by adjusting θ′ of the additional layer gθ′.

### [3-3: Technical Effects of the Learning Apparatus 3]

The learning apparatus 3 disclosed herein can generate the feature extraction model f_{θ} that is suitable for both extracting features for face matching and for detecting fake images.

### 4: Fourth Example Embodiment

A fourth example embodiment of the learning apparatus, information processing apparatus, learning method, and recording medium will be described below. The fourth example embodiment of the learning apparatus, information processing apparatus, learning method, and recording medium will be described below using a learning apparatus 4 according to the present disclosure.

In the fourth example embodiment, constraints are imposed to maintain the performance acquired through the second learning. In the fourth example embodiment, the feature extraction model generated through the second learning is subjected to the additional learning while imposing constraints to maintain the performance acquired through the second learning.

### [4-1: Learning Operations Performed by the Learning Apparatus 4]

In case where the feature extraction model is caused to perform the additional learning, a learning unit 412 restricts the additional learning. Specifically, the learning unit 412 restricts the adjustment of the parameter θ of the feature extraction model f_{θ} so that the more important the parameter θ_{Face} of the face matching feature extraction model f_{θFace} that underwent the second learning, the smaller the change in the parameter in the first learning.

The learning unit 412 may add a constraint term to the loss function to restrict the adjustment of each parameter θ of the feature extraction model f_{θ}. The constraint term is a term that acts to reduce the change in the parameter in the first learning as the importance of the parameter θ_{Face} of the face matching feature extraction model f_{θFace} that has undergone the second learning increases. The learning unit 412 may add a constraint term to the loss function that assigns importance to each parameter, as expressed in Formula 5 below.

$${\sum }_{i} \frac{λ}{2} {{F}_{i} ( {θ}_{i} - {θ}_{F a c e , i} )}^{2} \qquad [ Formula 5 ]$$

Fᵢ indicates the importance of the ith parameter θᵢ. That is, the larger Fᵢ is, the more the constraint term restricts the parameter θᵢ from being changed from the parameter θ_{Face} of the face matching feature extraction model f_{θFace}. Note that λ is a hyperparameter for adjusting the constraint strength.

The learning unit 412 may perform adjustments to minimize the loss and the constraint term simultaneously. That is, the learning unit 412 may operate to satisfy Formula 6 below.

$${min}_{θ} ( Loss ( θ ) + {\sum }_{i} \frac{λ}{2} {{F}_{i} ( {θ}_{i} - {θ}_{F a c e , i} )}^{2} ) \qquad [ Formula 6 ]$$

Importance may be assigned manually or automatically. In case where assigning importance automatically, it may be done using, for example, Fisher information (see Reference 1 below).
[Reference 1] Overcoming catastrophic forgetting in neural networks, arXiv 2016

### [4-2: Technical Effects of the Learning Apparatus 4]

The learning apparatus 4 disclosed herein constrains important parameters in the face recognition task to prevent large changes. This allows for the generation of the feature extraction model f_{θ} suitable for both extracting features for face matching and for detecting fake images.

### 5: Fifth Example Embodiment

The fifth example embodiment of the learning apparatus, information processing apparatus, learning method, and recording medium will be described. Below, the fifth example embodiment of the learning apparatus, information processing apparatus, learning method, and recording medium using a learning apparatus 5 according to the present disclosure will be described.

### [5-1: Learning Operation Performed by the Learning Apparatus 5]

A learning unit 512 causes the feature extraction model f_{θ} to perform a first learning of the feature extraction operation using the first image set D_{df} and a third image set D_{fr} to which an individual is labeled. The learning unit 512 may also cause the feature extraction model f_{θ} to perform a first learning of the feature extraction operation using the first image set D_{df} expressed as in Formula 1 above and the third image set D_{fr} expressed as in Formula 7 below.

$${D}_{fr} = {\{ {( {x}_{i}^{1} , {x}_{i}^{2} , {x}_{j} )}_{i} \}}_{i = 1}^{N} \qquad [ Formula 7 ]$$

xᵢ¹ and xᵢ² are face images of individual i, and xⱼ is a face image of individual j. In other words, the third image set D_{fr} contains N sets of two images of the same person and one image of another person. The learning unit 512 may use the first image set D_{df}, which contains N sets of two real images and one fake image, and the third image set D_{fr}, which contains N sets of two images of the same person and one image of another person.

The learning unit 512 performs the first learning of the feature extraction operation so that the first features extracted from a real image 1 are more similar to the third features extracted from a real image 2 than to the second features extracted from a fake image, and so that the fourth features extracted from an image 1 of the same person are more similar to the sixth features extracted from an image 2 of the same person than to the fifth features extracted from an image of another person. The learning unit 512 adjusts the parameter θ of the feature extraction model f_{θ} using a first loss function that reduces the loss in case where the similarity between the first features and the second features is smaller than the similarity between the first features and the third features, and a second loss function that reduces the loss in case where the similarity between the fourth features and the fifth features is smaller than the similarity between the fourth features and the sixth features. In other words, the learning unit 512 adjusts the parameter θ of the feature extraction model f_{θ} using a loss function that reduces the loss in case where the similarity between features extracted from images with different labels is smaller than the similarity between features extracted from images with the same label.

In case where triplet loss is used as the loss function, the first loss function can be expressed as in Formula 2 above. Furthermore, in case where triplet loss is used as the loss function, the second loss function can be expressed as shown in Formula 8 below.

$$[ Formula 8 ]$$

$$Loss ( θ , {x}_{i}^{1} , {x}_{i}^{2} , {x}_{j} ) = {[ dist ( {f}_{θ} ( {x}_{i}^{1} ) , {f}_{θ} ( {x}_{i}^{2} ) ) - dist ( {f}_{θ} ( {x}_{i}^{1} ) , {f}_{θ} ( {x}_{j} ) ) + α ]}_{+}$$

The learning unit 512 adjusts the parameter θ of the feature extraction model f_{θ} to minimize the loss function loss, optimizing the feature extraction model f_{θ}. That is, the learning unit 512 adjusts the parameter θ of the feature extraction model f_{θ} to achieve Formula 9 below.

$$[ Formula 9 ]$$

$${min}_{θ} {\sum }_{( {x}_{real}^{1} , {x}_{real}^{2} , {x}_{fake} ) ∈ {D}_{df}} {\sum }_{( {x}_{i}^{1} , {x}_{i}^{2} , {x}_{j} ) ∈ {D}_{fr}} Loss ( θ , {x}_{real}^{1} , {x}_{real}^{2} , {x}_{fake} ) + λ Loss ( θ , {x}_{i}^{1} , {x}_{i}^{2} , {x}_{j} )$$

Note that while triplet loss has been used as the second loss function, any loss function suitable for metric learning can be used as the second loss function.

The first learning described in the fifth example embodiment (first learning of the feature extraction operation using the first image set D_{df} and the third image set D_{fr}) may also be the additional learning performed on the second-learned face matching feature extraction model f_{θFace}, as described in the third and fourth example embodiments. That is, the learning unit 512 may perform additional learning using the loss functions expressed in Formula 2 and Formula 8 above, with θ as the initial parameter. In this case, the second image set and the third image set may be the same image set. Alternatively, the second image set and the third image set may be different image sets. The learning unit 512 may also adjust the parameter θ of the feature extraction model f_{θ} using a constraint such as that expressed in Formula 5 above.

### [5-2: Technical Effects of the Learning Apparatus 5]

The learning apparatus 5 according to the present disclosure learns to extract features used for face matching while also learning to extract features used for detecting the fake image. This allows it to generate a feature extraction model f_{θ} that is suitable for both extracting features used for face matching and detecting the fake image.

### 6: Sixth Example Embodiment

The sixth example embodiment of the learning apparatus, information processing apparatus, learning method, and recording medium will be described. Below, the sixth example embodiment of the learning apparatus, information processing apparatus, learning method, and recording medium using an information processing apparatus 6 according to the present disclosure will be explained.

### [6-1: Configuration of the Information Processing Apparatus 6]

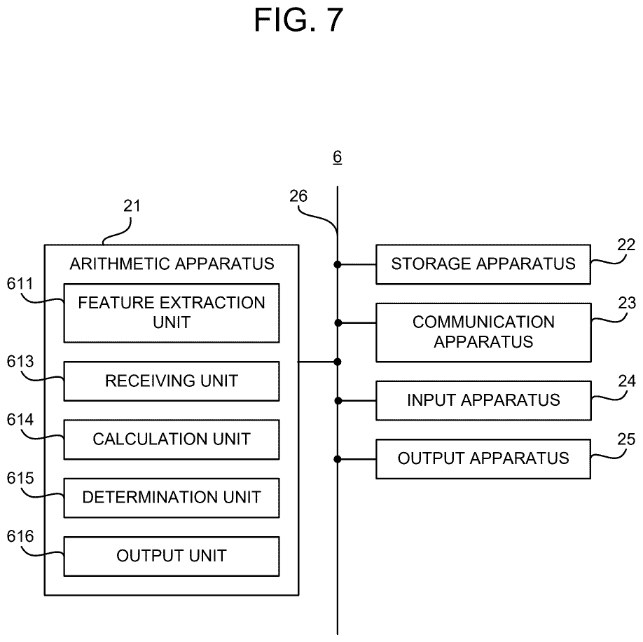

The configuration of the information processing apparatus 6 with reference to FIG. 7 will be described. FIG. 7 is a block diagram showing the configuration of the information processing apparatus 6.

As shown in FIG. 7, the information processing apparatus 6, like the learning apparatus 2 through the learning apparatus 5, includes the arithmetic apparatus 21, the storage apparatus 22, and the output apparatus 25. Furthermore, the information processing apparatus 6 may also include the communication apparatus 23 and the input apparatus 24, like the learning apparatus 2 through the learning apparatus 5. However, the information processing apparatus 6 does not necessarily have to include at least one of the communication apparatus 23 and the input apparatus 24. The information processing apparatus 6 implements a feature extraction unit 611, a receiving unit 613, a calculation unit 614, a determination unit 615, and an output unit 616 within the arithmetic apparatus 21.

### [6-2: Information Processing Operation Performed by the Information Processing Apparatus 6]

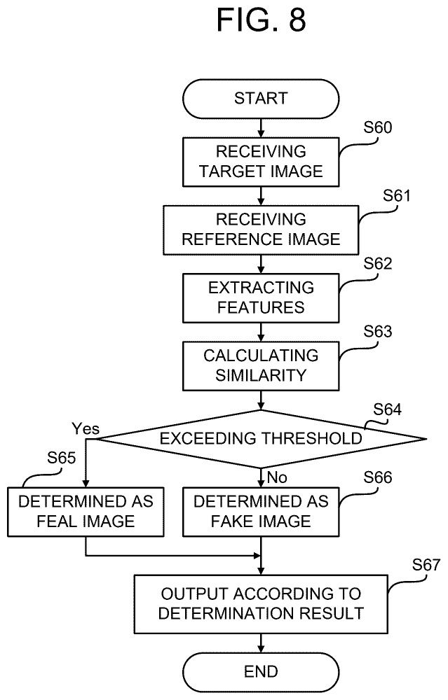

Referring to FIG. 8, the fake determination operation performed by the information processing apparatus 6 will be described. FIG. 8 is a flowchart showing an example of the fake determination operation performed by the information processing apparatus 6.

As shown in FIG. 8, the receiving unit 613 receives input of the target image of the determination target, which is determined to be synthesized or not (step S60). The receiving unit 613 may receive input of a face image including a person's face region as the target image. The target image may be a still image. The target image may be a moving image. The receiving unit 613 may acquire the target image via the communication apparatus 23 or the input apparatus 24.

The receiving unit 613 receives input of a reference image (step S61). The receiving unit 613 may receive input of a face image including a person's face region as the reference image. The reference image may be a still image. The reference image may be a moving image. The receiving unit 613 may acquire a registered image that has been registered in advance in the storage apparatus 22 as the reference image. Note that in the present disclosure, it is assumed that the reference image is the real image, not the fake image.

The feature extraction unit 611 extracts features from the image using the feature extraction model f_{θ}. The feature extraction model f_{θ} is a model that has undergone training using the learning apparatus of any of the first to fifth example embodiments. The feature extraction model f_{θ} is a model that has undergone at least the first training using at least the first image set D_{df}.

The feature extraction unit 611 extracts features (referred to as “target features”) from the target image. The feature extraction unit 611 also extracts features (referred to as “reference features”) from the reference image (step S62).

The calculation unit 614 calculates the similarity between the target features and the reference features (step S63). The determination unit 615 performs a threshold determination of the similarity. The determination unit 615 determines whether the similarity exceeds a threshold (step S64).

In case where the similarity exceeds the threshold (step S64: Yes), the determination unit 615 determines that the target image is the real image (step S65). In case where the similarity does not exceed the threshold (step S64: No), the determination unit 615 determines that the target image is the fake image (step S66).

The output unit 616 outputs according to the determination result (step S67). The output unit 616 may control the output apparatus 25 to cause the output apparatus 25 to output according to the determination result.

### [6-3: Technical Effects of the Information Processing Apparatus 6]

The information processing apparatus 6 disclosed herein uses at least the first image set D_{df} and features extracted using at least the first trained feature extraction model f_{θ} to determine whether or not an image is a fake image, thereby enabling accurate detection of the fake image.

### 7: Seventh Example Embodiment

The seventh example embodiment of the learning apparatus, information processing apparatus, learning method, and recording medium will be described. Below, an information processing apparatus 7 according to the present disclosure will be used to describe the learning apparatus, information processing apparatus, learning method, and recording medium.

### [7-1: Configuration of the Information Processing Apparatus 7]

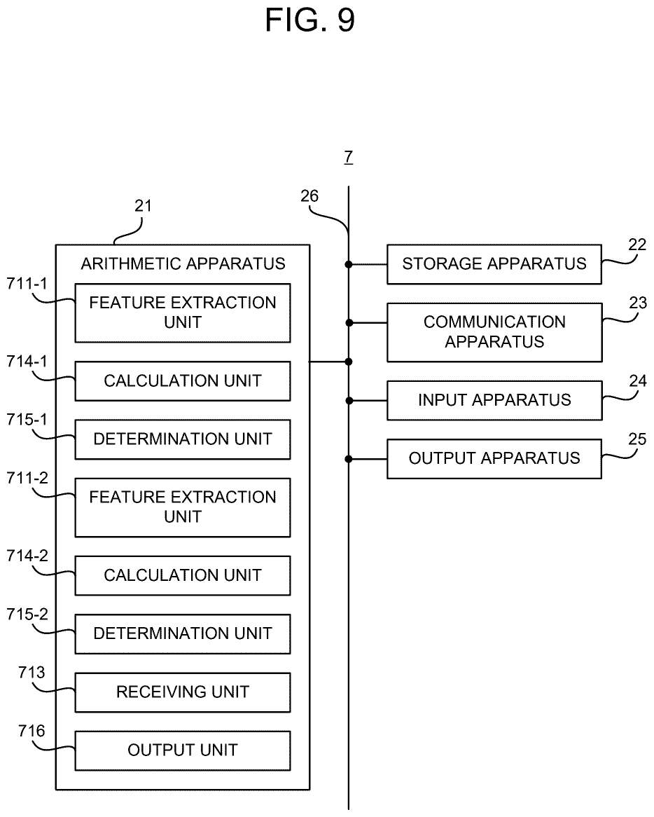

The configuration of the information processing apparatus 7 will be described with reference to FIG. 9. FIG. 9 is a block diagram showing the configuration of the information processing apparatus 7.

As shown in FIG. 9, the information processing apparatus 7, like the information processing apparatus 6, includes the arithmetic apparatus 21, the storage apparatus 22, and the output apparatus 25. Furthermore, the information processing apparatus 7 may also include the communication apparatus 23 and the input apparatus 24, like the information processing apparatus 6. However, the information processing apparatus 7 does not necessarily have to include at least one of the communication apparatus 23 and the input apparatus 24. The information processing apparatus 7 implements within the arithmetic apparatus 21 a first feature extraction unit 711_1, a first calculation unit 714_1, a first determination unit 715_1, a second feature extraction unit 711_2, a second calculation unit 714_2, a second determination unit 715_2, a receiving unit 713, and an output unit 716.

### [7-2: Information Processing Operation Performed by the Information Processing Apparatus 7]

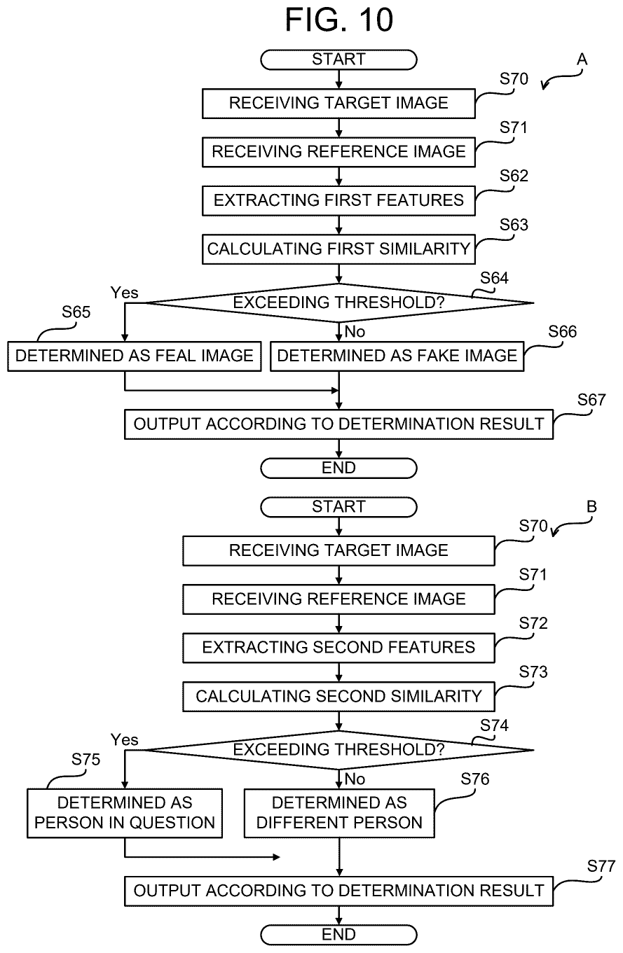

The authentication operation performed by the information processing apparatus 7 will be described with reference to FIG. 10. FIG. 10 is a flowchart showing an example of the authentication operation performed by the information processing apparatus 7.

As shown in flowchart A in FIG. 10, the receiving unit 713 receives input of a target image of a determination target on whether or not the person is the person in question (step S70). The receiving unit 713 may receive input of a face image including a person's face region as the target image. The target image may be a still image. The target image may be a moving image. The receiving unit 713 may acquire the target image via the communication apparatus 23 or the input apparatus 24.

The receiving unit 713 receives input of the reference image (step S71). The receiving unit 713 may receive input of a face image including a person's face region as the reference image. The reference image may be a still image. The reference image may be a moving image. The receiving unit 613 may acquire a registered image pre-registered in the storage apparatus 22 as the reference image.

The first feature extraction unit 711_1 extracts the first features from the image using the feature extraction model f_{θ}. The feature extraction model f_{θ} used by the first feature extraction unit 711_1 is a model trained using the learning apparatus of any of the first to fifth example embodiments. The feature extraction model f_{θ} used by the first feature extraction unit 711_1 is a model that has undergone at least a first learning process using at least the first image set D_{df}.

The first feature extraction unit 711_1 extracts first target features from the target image. Furthermore, the first feature extraction unit 711_1 extracts first reference features from the reference image (step S62).

The first calculation unit 714_1 calculates the first similarity between the first target features and the first reference features (step S63). The first determination unit 715_1 performs a threshold determination of the first similarity. The first determination unit 715_1 determines whether the first similarity exceeds the first threshold (step S64).

In case where the first similarity exceeds the first threshold (step S64: Yes), the first determination unit 715_1 determines that the target image is the real image (step S65). In case where the first similarity does not exceed the first threshold (step S64: No), the first determination unit 715_1 determines that the target image is the fake image (step S66).

The output unit 716 outputs according to the determination result (step S67). The output unit 716 may control the output apparatus 25 to make the output apparatus 25 output according to the determination result. In case where the first determination unit 715_1 determines that the target image is the real image, step S67 may be skipped and the information processing apparatus 7 may perform the operation shown in flowchart B of FIG. 10. On the other hand, in case where the first determination unit 715_1 determines that the target image is the fake image, the operation may end without performing the operation shown in flowchart B of FIG. 10.

The target image and the reference image used in the operation shown in flowchart B of FIG. 10 are the target image and the reference image used in the operation shown in flowchart A of FIG. 10. Therefore, in case where executing the operation shown in flowchart B of FIG. 10 following the operation shown in flowchart A of FIG. 10, the operations of steps S70 and S71 may be skipped.

As shown in flowchart B of FIG. 10, the second feature extraction unit 711_2 extracts second features from the image using the feature extraction model f_{θ}. The feature extraction model f_{θ} used by the second feature extraction unit 711_2 is a model that has undergone at least a second learning process using at least the second image set D_{fr}. The feature extraction model f_{θ} used by the second feature extraction unit 711_2 may be a model that has undergone learning using the learning apparatus of any of the third to fifth example embodiments. The feature extraction model f_{A} used by the second feature extraction unit 711_2 may be the same model as the feature extraction model f_{θ} used by the first feature extraction unit 711_1. The feature extraction model used by the second feature extraction unit 711_2 may be a model that has not undergone the first learning using the first image set D_{df}.

The second feature extraction unit 711_2 extracts second target features from the target image. The second feature extraction unit 711_2 also extracts second reference features from the reference image (step S72).

The second calculation unit 714_2 calculates the second similarity between the second target features and the second reference features (Step S73). The second determination unit 7152 performs a threshold determination of the second similarity. The first determination unit 715_1 determines whether the second similarity exceeds the second threshold (Step S74).

In case where the second similarity exceeds the second threshold (Step S74: Yes), the second determination unit 715_2 determines that the person appearing in the target image and the person appearing in the reference image are the same person, and that the person appearing in the target image is the person in question (Step S75). In case the second similarity does not exceed the second threshold (step S74: No), the second determination unit 715_2 determines that the person appearing in the target image and the person appearing in the reference image are different person (step S76).

The output unit 716 outputs according to the determination result (step S77). The output unit 716 may control the output apparatus 25 to cause the output apparatus 25 to output according to the determination result.

The information processing apparatus 7 may first perform the operation shown in flowchart B of FIG. 10, and then perform the operation shown in flowchart A of FIG. 10 after the operation shown in flowchart B of FIG. 10. In this case, in case where the second determination unit 715_2 determines that the person appearing in the target image and the person appearing in the reference image are different person, it may end its operation without performing the operation shown in flowchart A of FIG. 10.

Furthermore, the information processing apparatus 7 may perform the operations shown in Flowchart A of FIG. 10 and Flowchart B of FIG. 10 in parallel. In this case, the information processing apparatus 7 may determine whether or not to recognize the person appearing in the target image based on the relationship between the first similarity and the first threshold value, and the relationship between the second similarity and the second threshold value.

### [7-3: Technical Effects of the Information Processing Apparatus 7]

The information processing apparatus 7 according to the present disclosure can accurately detect whether the input determination target video is a fake video, thereby enabling accurate identity verification.

### 8: Supplementary Notes

The following supplementary notes are further disclosed regarding the above-described example embodiment.

### [Supplementary Note 1]

A learning apparatus including:
a feature extraction means for extracting features from an image; and
a learning means for causing the feature extraction means to perform a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than to second features extracted from a second image labeled with the synthetic label.

### [Supplementary Note 2]

The learning apparatus according to Supplementary Note 1, wherein
the feature extraction means executes the feature extraction operation using a feature extraction model that outputs features of an image in a case where the image is input, and
the learning means performs the first learning by adjusting parameters of the feature extraction model using a loss function that reduces loss in a case where the similarity between the first features and the second features is smaller than the similarity between the first features and the third features.

### [Supplementary Note 3]

The learning apparatus according to Supplementary Note 1, wherein
the learning means causes the feature extraction means to perform the first learning of the feature extraction operation using the first image set and a third image set labeled with an individual identifying label, so that the first features is more similar to the third features than to the second features, and so that features extracted from images labeled with the same label are more similar to each other than features extracted from images labeled with different labels.

### [Supplementary Note 4]

The learning apparatus according to Supplementary Note 3, wherein
the feature extraction means, in a case where an image is input, performs the feature extraction operation using a feature extraction model that outputs features of an image, and
the learning means performs the first learning by adjusting parameters of the feature extraction model using a loss function that reduces loss in a case where the similarity between the first features and the second features is smaller than the similarity between the first features and the third features, and the loss function that reduces loss in a case where the similarity between the features extracted from the images with different labels is smaller than the similarity between the features extracted from the images with the same label.

### [Supplementary Note 5]

The learning apparatus according to any one of Supplementary Notes 1 to 4, wherein
the learning means causes the feature extraction means, which has performed a second learning of the feature extraction operation so that features extracted from images with the same label are more similar to each other than features extracted from images with different labels using a second image set labeled to identify individuals, to perform the first learning.

### [Supplementary Note 6]

The learning apparatus according to Supplementary Note 2 or 4, wherein
the learning means, in a case where causing the feature extraction means, which has performed a second learning of the feature extraction operation so that features extracted from images with the same label are more similar to each other than features extracted from images with different labels using a second image set labeled to identify individuals, to perform the first learning, restricts adjustment of the parameters of the feature extraction model so that more important parameter is among the parameters of the feature extraction model that has undergone the second learning, the smaller the change in the parameter in the first learning.

### [Supplementary Note 7]

An information processing apparatus including:
a first feature extraction means that has performed a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than second features extracted from a second image labeled with the synthetic label;
a first calculation means that calculates a similarity between target features extracted by the first feature extraction means from a target image that is to be determined as to whether or not it has been synthesized, and reference features extracted by the first feature extraction means from a reference image;
a determination means that performs a determination whether or not the target image has been synthesized by determining a threshold value of the similarity; and
an output means that produces an output according to a result of the determination by the determination means.

### [Supplementary Note 8]

An information processing apparatus including:
a second feature extraction means that has performed a second learning of the feature extraction operation so that features extracted from images with the same label are more similar to each other than features extracted from images with different labels using a second image set labeled to identify individuals, wherein the second feature extraction means that has performed a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than second features extracted from a second image labeled with the synthetic label;
a second calculation means that calculates a similarity between target features extracted by the second feature extraction means from a target image of a determination target on whether or not the person is the person in question, and reference features extracted by the second feature extraction means from a reference image;
a second determination means that performs a determination whether the determination target is the person in question or not by a threshold determination for the similarity; and
an output means for outputting according to a result of the determination by the second determination means.

### [Supplementary Note 9]

A learning method including:
extracting features from an image using a feature extraction model; and
causing the feature extraction model to perform a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than to second features extracted from a second image labeled with the synthetic label.

### [Supplementary Note 10]

A recording medium on which a computer program is stored, the computer program being configured to allow a computer to execute a learning method including:
extracting features from an image using a feature extraction model; and
causing the feature extraction model to perform a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than to second features extracted from a second image labeled with the synthetic label.

Although the present disclosure has been described above with reference to the exemplary example embodiment, the present disclosure is not restricted to the above-described example embodiment. Various modifications within the scope of the present disclosure that would be understood by those skilled in the art can be made to the configuration and details of the present disclosure. Each example embodiment can be combined with other example embodiments as appropriate.

### DESCRIPTION OF REFERENCE CODES

1, 2, 3, 4, 5 learning apparatus
11, 211, 311, 411, 511, 611 feature extraction unit
12, 212, 312, 412, 512 learning unit
6, 7 information processing apparatus
613, 713 receiving unit
614 calculation unit
615 determination unit
616, 716 output unit
711_1 first feature extraction unit
711_2 second feature extraction unit
714_1 first calculation unit
714_2 second calculation unit
715_1 first determination unit
715_2 second determination unit

What is claimed is:

1. A learning apparatus comprising:
at least one memory storing instructions; and
at least one processor that is configured to execute the instructions for:
extracting features from an image using a feature extraction model; and
causing the feature extraction model to perform a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than to second features extracted from a second image labeled with the synthetic label.

2. The learning apparatus according to claim 1, wherein the at least one processor that is configured to execute the instructions for:
executing the feature extraction operation using the feature extraction model that outputs features of an image in a case where the image is input; and
performing the first learning by adjusting parameters of the feature extraction model using a loss function that reduces loss in a case where the similarity between the first features and the second features is smaller than the similarity between the first features and the third features.

3. The learning apparatus according to claim 1, wherein
causing the feature extraction model to perform the first learning of the feature extraction operation using the first image set and a third image set labeled with an individual identifying label, so that the first features is more similar to the third features than to the second features, and so that features extracted from images labeled with the same label are more similar to each other than features extracted from images labeled with different labels.

4. The learning apparatus according to claim 3, wherein the at least one processor that is configured to execute the instructions for:
in a case where an image is input, performing the feature extraction operation using the feature extraction model that outputs features of an image; and
performing the first learning by adjusting parameters of the feature extraction model using a loss function that reduces loss in a case where the similarity between the first features and the second features is smaller than the similarity between the first features and the third features, and the loss function that reduces loss in a case where the similarity between the features extracted from the images with different labels is smaller than the similarity between the features extracted from the images with the same label.

5. The learning apparatus according to claim 1, wherein the at least one processor that is configured to execute the instructions for
causing the feature extraction model, which has performed a second learning of the feature extraction operation so that features extracted from images with the same label are more similar to each other than features extracted from images with different labels using a second image set labeled to identify individuals, to perform the first learning.

6. The learning apparatus according to claim 2, wherein
in a case where causing the feature extraction model, which has performed a second learning of the feature extraction operation so that features extracted from images with the same label are more similar to each other than features extracted from images with different labels using a second image set labeled to identify individuals, to perform the first learning, the at least one processor that is configured to execute the instructions for restricting adjustment of the parameters of the feature extraction model so that more important parameter is among the parameters of the feature extraction model that has undergone the second learning, the smaller the change in the parameter in the first learning.

7. An information processing apparatus comprising:
a first feature extraction model that has performed a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than second features extracted from a second image labeled with the synthetic label;
at least one memory storing instructions; and
at least one processor that is configured to execute the instructions for:
calculating a similarity between target features extracted by the first feature extraction model from a target image that is to be determined as to whether or not it has been synthesized, and reference features extracted by the first feature extraction model from a reference image;
performing a determination whether or not the target image has been synthesized by determining a threshold value of the similarity; and
producing an output according to a result of the determination.

8. An information processing apparatus comprising:
a second feature extraction model that has performed a second learning of the feature extraction operation so that features extracted from images with the same label are more similar to each other than features extracted from images with different labels using a second image set labeled to identify individuals, wherein the second feature extraction model that has performed a first learning of a feature extraction operation using a first image set including images labeled with a non-synthetic label indicating that the images are not synthesized and images labeled with a synthetic label indicating that the images are synthesized, so that first features extracted from a first image labeled with the non-synthetic label is more similar to third features extracted from a third image different from the first image labeled with the non-synthetic label than second features extracted from a second image labeled with the synthetic label;
at least one memory storing instructions; and
at least one processor that is configured to execute the instructions for:
calculating a similarity between target features extracted by the second feature extraction model from a target image of a determination target on whether or not the person is the person in question, and reference features extracted by the second feature extraction model from a reference image;
performing a determination whether the determination target is the person in question or not by a threshold determination for the similarity; and
outputting according to a result of the determination.

9-10. (canceled)
